(19) United States
(12) Patent Application Publication
(10) Pub. No.: US 2007/0006711 A1
(43) Pub. Date: Jan. 11, 2007

(54) Ultimate Banjo Mute

(75) Inventor: Dave P Spencer, Titusville, FL (US)

Correspondence Address: DAVE SPENCER, 1185 BONNYMEDE DR., TITUSVILLE, FL, 32796, US

(73) Assignee: Dave Philip Spencer, Titusville, FL (US)

(21) Appl. No.: 11/308,437

(22) Filed: Mar. 24, 2006

Related U.S. Application Data
(60) Provisional application No. 60/595,436, filed on Jul. 5, 2005.

(30) Foreign Application Priority Data
Feb. 22, 2006 (CL) 60595436

(51) Int. Cl. G10D 3/04

(52) U.S. Cl. 84/310

(57) ABSTRACT

This mute is simple in design and makes it easy for soft practice with warm tone.

### DESCRIPTION

This invention relates to a banjo mute. It has the following components:

The first component is a piece of brass ¼ inch wide by 0.093 inches thick and two and one half inches long as the main body.

The main body then has a strip of Velcro put on one side of the brass for sound dampening.

The brass strip is then bent evenly in half.

A notch is then cut at the rounded part of the mute body 0.135 inches long and 0.225 inches deep, and then de-burred and polished.

What is claimed is:

1. This banjo mute works by simply sliding it onto the bridge and under the strings of the banjo.

2. This is the only banjo mute that will work on all 4, 5, and 6 string banjos.

3. This mute is designed so it will not hinder the right hand movement when playing the banjo.

4. The same concept of this mute will also work on a violin, cello, or upright Bass, because the same physics are used.
